(19) United States
(12) Patent Application Publication
(10) Pub. No.: US 2006/0026971 A1
(43) Pub. Date: Feb. 9, 2006

(54) Systems and methods for determining and monitoring wine temperature

(76) Inventor: Richard Sharpe, Woodridge, IL (US)

Correspondence Address: LATHROP & GAGE LC, 4845 PEARL EAST CIRCLE, SUITE 300, BOULDER, CO, 80301, US

(21) Appl. No.: 11/175,243

(22) Filed: Jul. 6, 2005

Related U.S. Application Data
(60) Provisional application No. 60/585,684, filed on Jul. 6, 2004.

(51) Int. Cl. F25B 49/00; G01K 13/00

(52) U.S. Cl. 62/126; 62/129

(57) ABSTRACT

A system for determining and monitoring wine temperature includes a housing, a first temperature sensor for sensing an ambient temperature and a second temperature sensor for sensing the temperature of a wine bottle, for example without opening the bottle. A processor processes the ambient temperature with the wine bottle temperature to determine the temperature of wine within the bottle. Measured temperatures may be displayed in Celsius or Fahrenheit units on a display, responsive to user inputs. A user may select a target wine temperature, which may further be displayed. The system may fit around the neck of the wine bottle or over the cork of the wine bottle, or the system may be configured as a coaster. Sensors may be contact or non-contact sensors such as infrared sensors. In one embodiment, an infrared system for determining and monitoring wine temperature is provided as a bottle stopper that replaces the cork of a wine bottle.

### RELATED APPLICATIONS

This application claims the benefit of priority to U.S. Provisional Patent Application No. 60/585,684, filed Jul. 6, 2004 and incorporated herein by reference.

### BACKGROUND

In order to fully appreciate the flavor of wine, it is often desirable to serve the wine at a particular temperature. For example, white and sparkling wines are generally best served at cooler temperatures which play up fresh, fruity aspects while minimizing sweetness. Red wines may taste too harsh when chilled, due to the presence of tannins. Red wines, in particular old reds, are thus preferably served at warmer temperatures that allow their flavors and aromas to unfold. However, following a general rule of serving red wines warm and white wines cool, without monitoring the temperature, may result in a suboptimal wine tasting experience. For example, overly warm temperatures make the smell of alcohol emerge too strongly and the wine taste overly “hot”. A temperature that is too cool may prevent a wine from properly unfolding and may also chill the gustatory papillae on the tongue, inhibiting the ability to distinguish sweet and sour flavors and thus further diminishing the tasting experience.

In addition, different varietals of red and white wines may have different ideal serving temperatures. Wine producers often indicate proper serving temperatures on wine bottle labels, so that a consumer may enjoy the wine at the temperature best suited to its type and characteristics. An optimal wine drinking experience depends not only on the temperature of the wine, be it red or white, but also on the difference between the wine temperature and its ideal drinking temperature. As wine warms, vapors rise from its surface, allowing a drinker to smell the wine. The sense of smell is critical to the overall taste of any food or beverage, thus, the fullest taste experience is achieved while the wine is still warming. When served cold, white wines naturally vaporize as they warm to room temperature, assuming room temperature is warmer than the wine temperature. In order to achieve the vaporizing effect in a red wine, it may be necessary to first cool the wine to a few degrees below its ideal drinking temperature and/or room temperature, especially if the wine has been stored in a relatively warm room. This allows the wine to warm slightly and vaporize, for example, in a glass.

Prior art methods of measuring wine temperature include affixing thermal stickers to wine bottles, and inserting a temperature probe directly into the wine. The following patents and published patent application provide useful background information and are incorporated herein by reference: U.S. Pat. No. 4,538,926; U.S. Pat. No. 4,878,588; U.S. Pat. No. 4,919,983; U.S. Pat. No. 4,962,765; U.S. Pat. No. 5,482,373; U.S. Pat. No. 5,553,941; U.S. Pat. No. 5,720,555; U.S. Pat. No. 5,738,442; U.S. Pat. No. 5,983,783; U.S. Pat. No. 5,997,927; U.S. Pat. No. 8,000,845; U.S. Pat. No. 6,536,306; U.S. Pat. No. 6,158,227, U.S. Pat. No. D404491; and U.S. Patent Application Publication No. 2001/0040911.

### SUMMARY OF THE INVENTION

Prior art methods are generally inadequate for measuring and achieving optimal wine drinking temperatures. For example, the above-mentioned thermal stickers indicate the temperature of the bottle, not the wine inside. Placing a probe in physical contact with the wine can contaminate the wine and alter its taste, for example due to residues left on the probe from tests of prior wines, or even detergents used to clean the probe between measurements. The disclosed systems and methods may provide, for example, for efficient, accurate and sanitary determination and monitoring of wine temperature.

In one embodiment, a system for determining and monitoring wine temperature includes a housing with a first sensor and second temperature sensors supported by the housing. The first temperature sensor produces signals representative of an ambient temperature and the second temperature sensor produces signals representative of a wine bottle temperature. A processor supported by the housing acts upon the first and second signals to determine a temperature of wine within a wine bottle.

In one embodiment, A coaster for determining and monitoring beverage temperature has a base and a top, the top having a cavity for accepting a beverage container a temperature sensor disposed within the cavity produces signals representative of a temperature of a beverage within the beverage container.

In one embodiment, a method of determining wine temperature includes sensing a first temperature of a wine bottle, sensing a first ambient temperature and processing the wine bottle temperature with the ambient temperature to determine a emperature of wine within the bottle

### BRIEF DESCRIPTION OF THE FIGURES

FIG. 1 is a block diagram of a system for determining and monitoring wine temperature.

FIG. 2A depicts another system for determining and monitoring wine temperature.

FIG. 2B is a right side view of the system of FIG. 2A.

FIG. 2C is a left side view of the system of FIG. 2A.

FIG. 2D is an end view of the system of FIG. 2A.

FIG. 2E depicts another system for determining and monitoring wine temperature.

FIG. 2F is a right side view of the system of FIG. 2E.

FIG. 2G is a left side view of the system of FIG. 2E.

FIG. 2H is a perspective view of the system of FIG. 2E, around the neck of a wine bottle.

FIG. 2I is another view of the system of FIG. 2E, with dimensions.

FIG. 2J is a perspective view of another system for determining and monitoring wine temperature, with alternately positioned display and user inputs.

FIG. 2K is another perspective view of the system of FIG. 2J.

FIG. 3 shows a display panel for a system for determining and monitoring wine temperature.

FIG. 4A illustrates a hinged clasp system for determining and monitoring wine temperature.

FIG. 4B shows a collar system for determining and monitoring wine temperature.

FIG. 5 shows a cap system for placing over a wine bottle cork to determine and monitor the temperature of wine within the bottle.

FIG. 6 depicts a coaster system for determining and monitoring wine temperature from the base of a wine bottle.

FIG. 7A depicts a bottle stopper system for determining and monitoring wine temperature.

FIG. 7B is a rear view of the system of FIG. 7A.

FIG. 7C is a side view of the system of FIG. 7A.

FIG. 7D shows the system of FIGS. 7A-C in a wine bottle.

FIGS. 8A-C are flowcharts illustrating an operational logic process utilized in a system for determining and monitoring wine temperature.

FIG. 9 is a graph illustrating relationships between wine bottle neck temperature and wine temperature over a period of time.

FIG. 10 is a graph illustrating differences between calculated and actual wine and ambient temperatures, obtained in testing a system for determining and monitoring wine temperature.

### DETAILED DESCRIPTION OF THE FIGURES

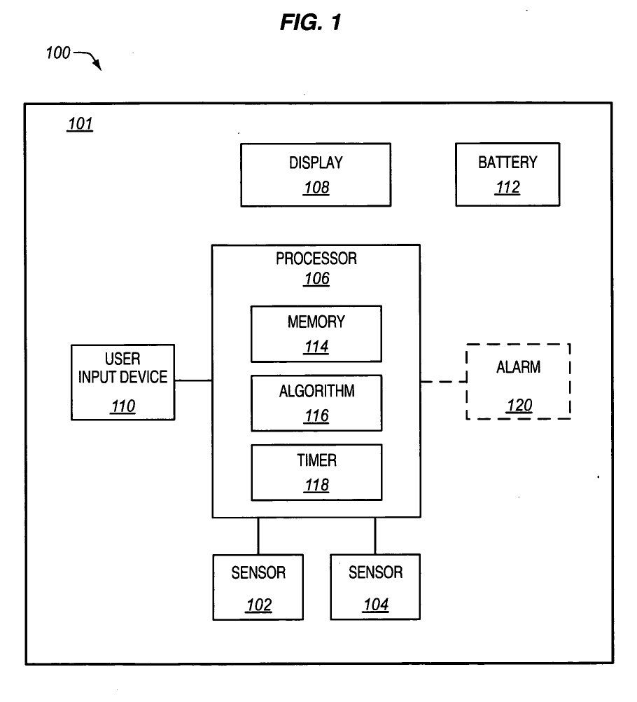

There will now be shown and described a system for determining and monitoring wine temperature. The instrumentalities shown may, for example, be included in a sealed housing and may be implemented as a combination of circuitry and program logic. First and second temperature sensors are used, respectively, to record ambient temperature and wine bottle temperature. A processor receives signals from these sensors and processes the signals to determine temperature of wine in the bottle. FIG. 1 illustrates one embodiment of a system 100 for determining wine temperature. System 100 includes a housing 101 for housing an ambient temperature sensor 102, a wine temperature sensor 104, a processor 106, a display 108, a user input device 110 and a battery 112. In at least one embodiment, system 100 is a wireless, digital system. In one embodiment, sensor 104 is a thermocouple.

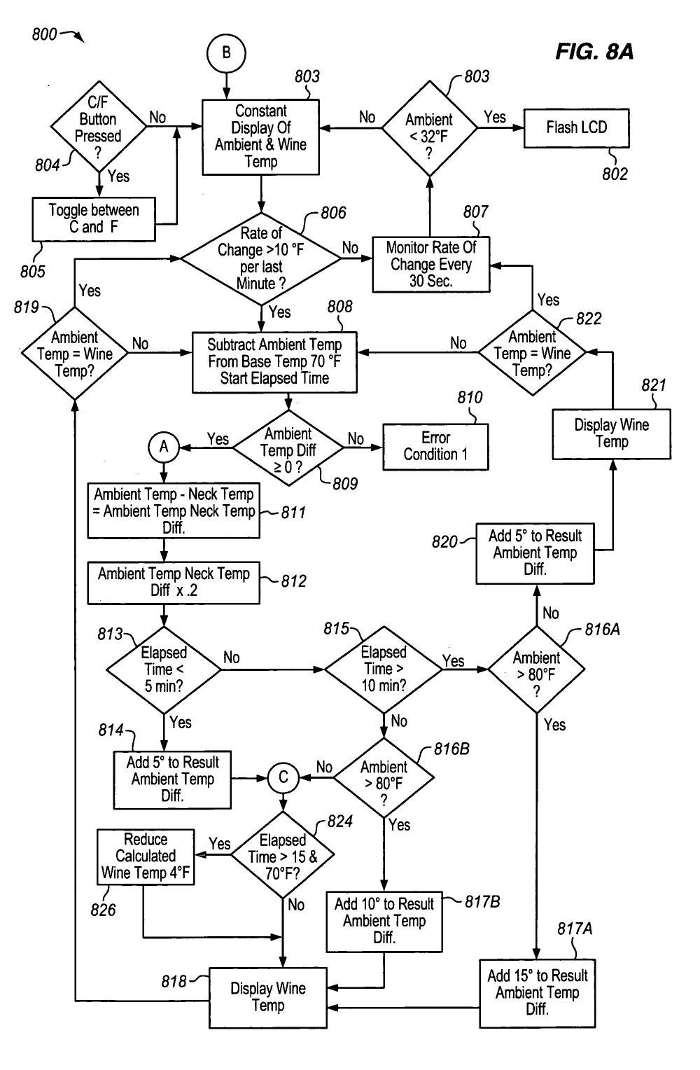

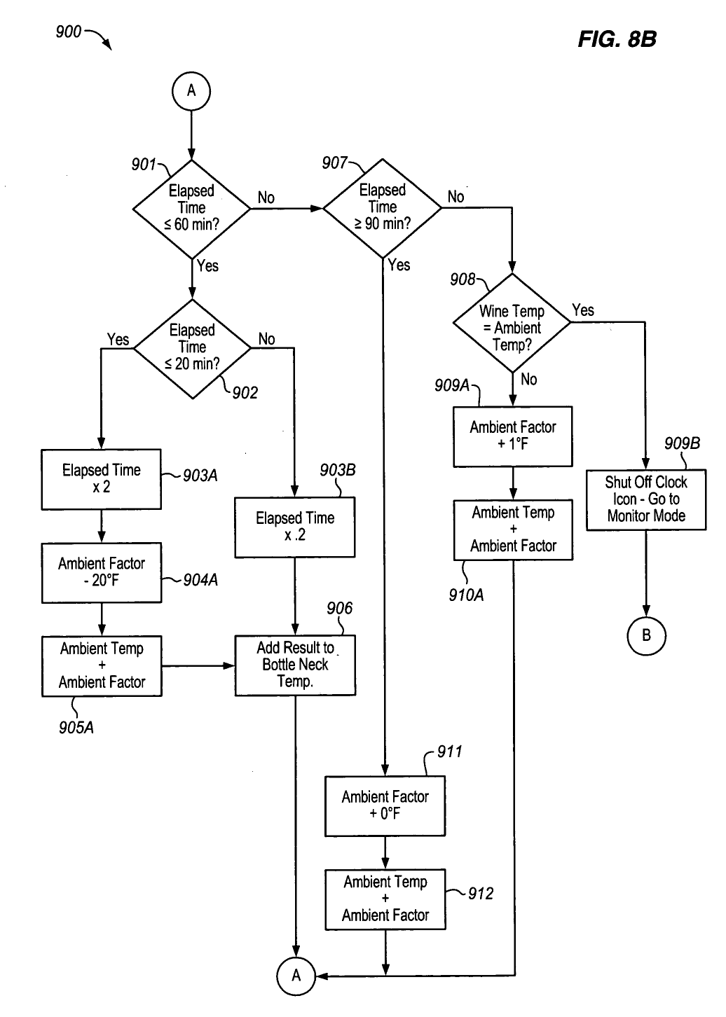

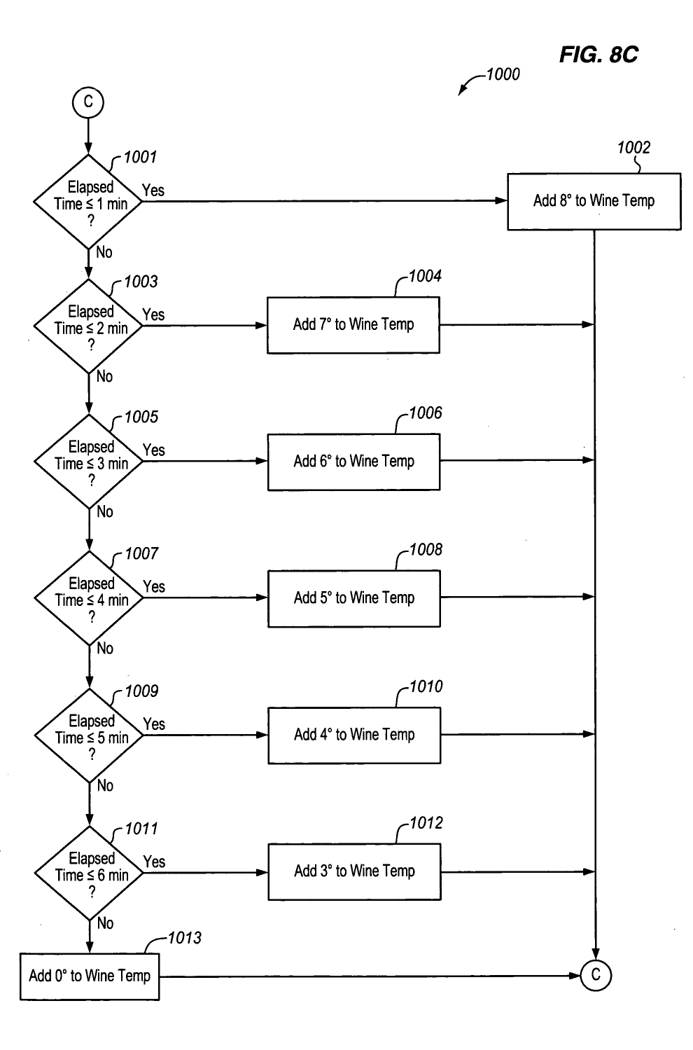

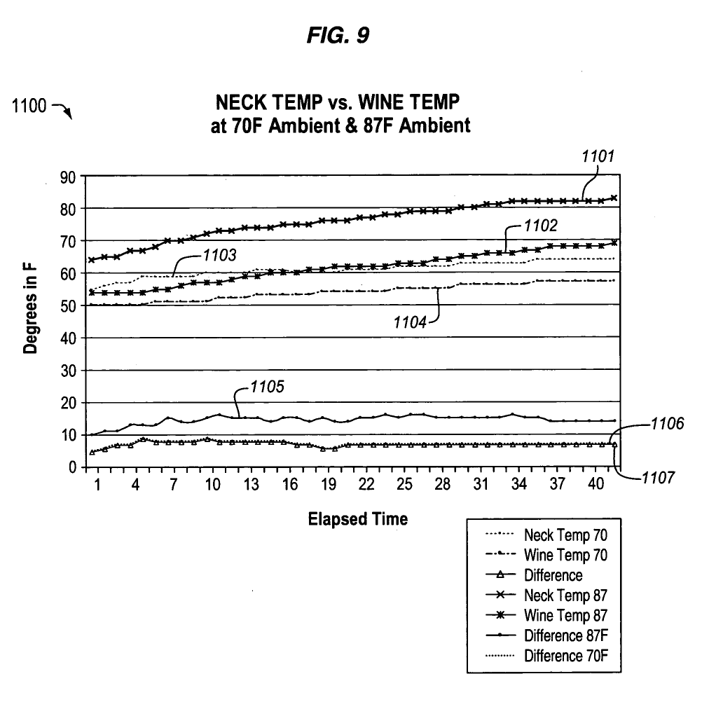

Processor 106 includes a memory 114, at least one algorithm 116 and a timer 118. Processor 106 may be a microcontroller or microprocessor, for example an integrated chip. Processor 106 may execute an algorithm 116 to determine wine temperature from temperatures measured by sensors 102, 104. In particular, processor 106 utilizes timer 118 to periodically read ambient temperature, using sensor 102 and wine bottle temperature using sensor 104. Read temperatures may for example be stored in memory 114. Algorithm 116 may determine wine temperature based upon (a) rate of change in ambient temperature, (b) rate of change in wine bottle temperature, and (c) current wine bottle temperature. For example, rate of ambient temperature change (AA) may be measured according to the following equation:

$$Δ A = \frac{{A}_{2} - {A}_{1}}{{T}_{2} - {T}_{1}} \qquad Equation 1$$

where A₁ is a first ambient temperature measurement taken at time T_{1 and A}₂ is a second ambient temperature measurement, taken at time T₂. The rate of wine bottle temperature change (ΔB) may likewise be measured according to:

$$Δ B = \frac{{B}_{2} - {B}_{1}}{{T}_{2} - {T}_{1}} \qquad Equation 2$$

where B₁ is a first wine bottle temperature taken at time T₁, and B₂ is a second wine bottle temperature, taken at time T₂. Algorithm 116 may then be utilized by processor 106 to calculate wine temperature, for example as shown in the operational logic charts of FIGS. 8A-C and according to differences in wine and neck temperatures over time, as illustrated in the graph of FIG. 9. Further, system 100 may be utilized with different sizes of wine bottles having different thicknesses. An algorithm 116 may also be utilized to account for different bottle thicknesses (and thus different temperature conductivities), for example by calibrating system 100 up or down several degrees according to bottle thickness.

User input device 110 may include one or more buttons for inputting user requests from a user to processor 106. As used herein, buttons include press-buttons, switches, touch-screen buttons and other means of touch-based input. Alternately, user input device 110 may be a voice recognition input device, such that a user may control system 100 through spoken requests or commands.

One button of user input device 110 may allow the user to select between displaying temperature in Fahrenheit or Celsius units. Responsive to user selection, processor 106 may utilize an algorithm 116 to convert between Fahrenheit and Celsius units. For example, algorithm 116 may be an algorithm for converting between Fahrenheit to Celsius, according the following equation:

$$C = \frac{5}{9} ( F - 32 ) \qquad Equation 3$$

An algorithm 116 may likewise be utilized to convert from Celsius to Fahrenheit, according to the following equation:

$$F = \frac{9}{5} C + 32 \qquad Equation 4$$

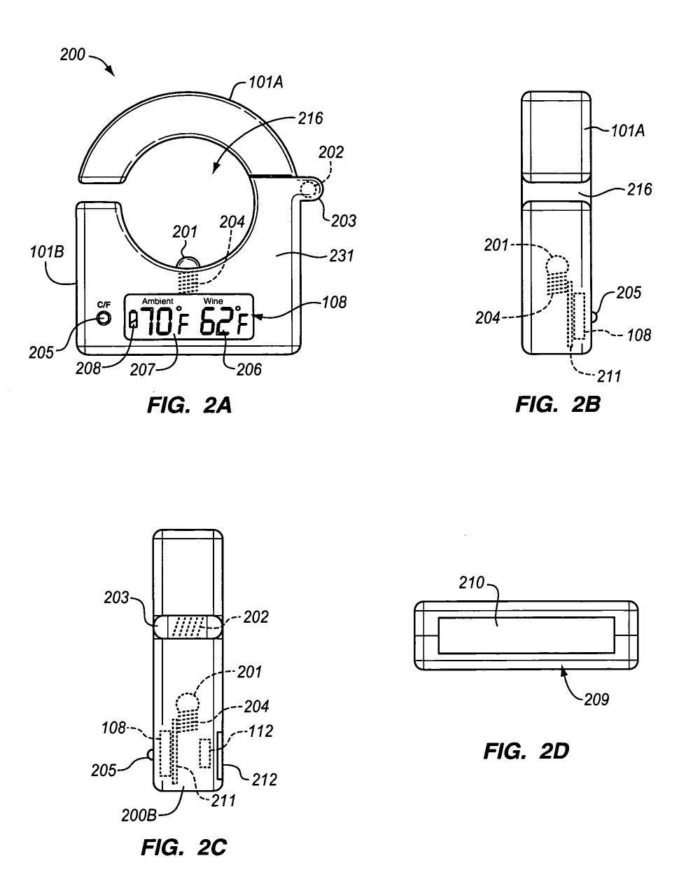

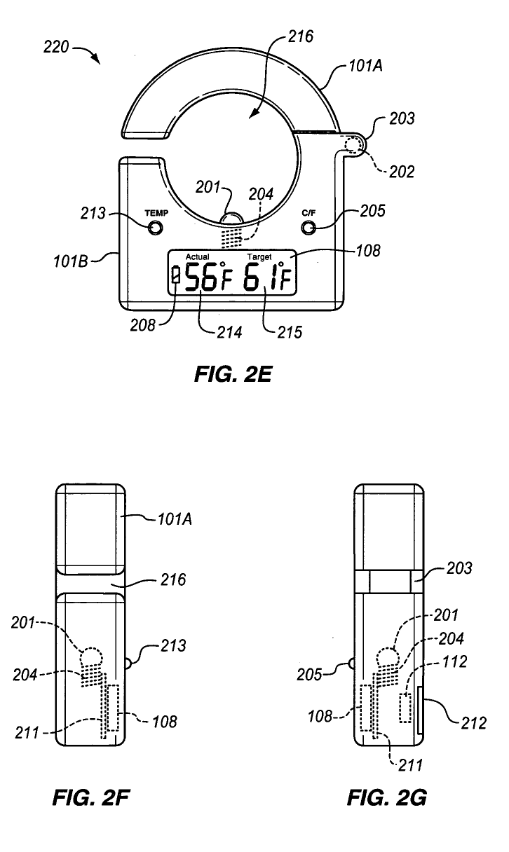

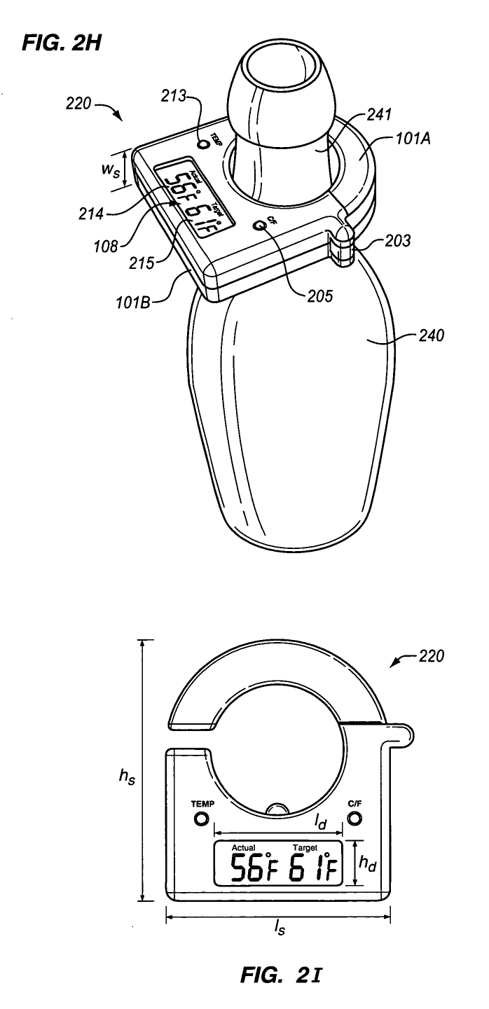

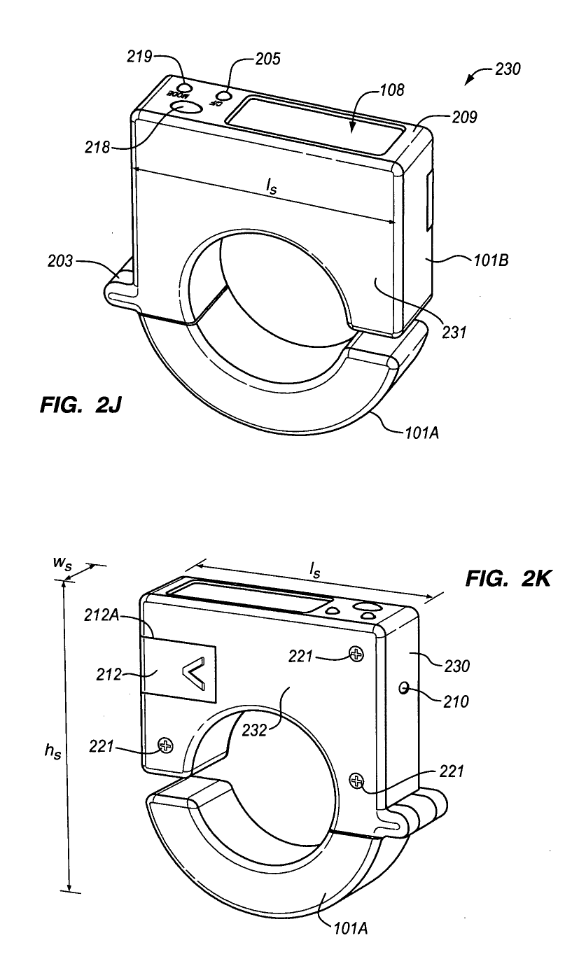

The same or another button of user input device 110 may allow for selection between views on display 108. For example, the user may employ one or more button presses to toggle between a first display view, showing ambient and wine temperature as in FIG. 2A, and a second display view showing actual and target wine temperature as in FIG. 2B.

Processor 106, display 108, user input device 110 and sensors 102 and 104 may be powered by a battery 112. In one embodiment, battery 112 is a Lithium button cell, providing system 100 with about 360 hours of operating power. Battery 112 may additionally power an alarm 120, for informing the user when a pre-set parameter such as a desired wine temperature, or an emergency status such as a low battery state, occurs. Alarm 120 may be a visual and/or audio alarm. For example, alarm 120 may be a steady or blinking light. Alarm 120 may optionally or additionally emit sound, for example buzzing or beeping when a desired wine temperature is reached.

FIG. 2A shows a top view of one embodiment of a system for determining and monitoring wine temperature. System 200 is configured to fit around the neck of a wine bottle. In at least one embodiment, system 200 includes a housing, e.g., housing 101, FIG. 1, made up of an arm section 101A and a body section 101B, the arm and body sections 101A, 101B defining an elliptical opening 216 therebetween. Elliptical opening 216 is sized to accommodate the neck of the wine bottle. In one embodiment, a spring-loaded sensor 201, mounted with spring 204 and disposed along elliptical opening 216, senses the temperature of a wine bottle neck when system 200 is placed around the neck of the wine bottle such that sensor 201 contacts the neck. Sensor 201 is shown in FIG. 2A as a spring-loaded sensor mounted on a spring 204; however, sensor 201 may also be fixedly mounted with housing 200 such that spring 204 is not utilized.

In one embodiment, arm section 101A and body section 101B may be connected by a hinge 203. Hinge 203 may include a spring 202 for maintaining system 200 in a closed position. System 200 may be opened by applying opposing forces to arm and body sections 101A, 101B, for example by pulling arm and body sections 101A, 101B apart, opposite hinge 203, with a force sufficient to compress spring 202. System 200 may then be placed around the neck of a wine bottle, and closed by releasing arm and body sections 101A, 101B. Once closed, sensor 201 may contact and measure temperature of the wine bottle neck. Conveniently, system 200 may determine the temperature of wine within a sealed bottle, thus allowing for optimal vaporization once the wine reaches the desired temperature and the bottle is opened. In other words, because the bottle remains sealed, vapors do not escape during warming or cooling, and vaporization occurs once the wine is opened, poured and served. System 200 may remain attached to a wine bottle while the bottle is stored in a cellar, for example to monitor cellar temperature, or while the bottle is being cooled, for example with a wine cooling sleeve or in a refrigerator or cooler. System 200 likewise may measure and monitor wine temperature when a bottle is removed from storage or cooling to warm to room temperature.

Ambient temperature may be measured by an ambient temperature sensor 210, shown disposed upon an end 209 of system 200, in FIG. 2D. It is to be understood that ambient temperature sensor 210 may be placed at any position that allows for acceptable measurement of ambient temperature. Further, there is no requirement for a particular shape or size of ambient temperature sensor 210.

Both an ambient temperature reading 207 and a wine temperature reading 206 may be displayed upon display 108, which may for example be an LCD display. A user may select or toggle between Celsius and Fahrenheit measurements of ambient and wine temperature readings 207, 206 by pressing a C/F (Celsius/Fahrenheit) button 205. As shown in FIG. 2A, display 108 and C/F button 205 are disposed with body section 101B on a top face 231; however, it is to be understood that one or both of display 108 and C/F button 205 may equally be disposed with arm section 101A, or at any position on system 200 that allows convenient user access.

As shown in side view FIGS. 2B and 2C, system 200 may include a printed circuit board (PCB) 211, battery 112 and battery cover 212. PCB 211 may be configured with a processor (e.g., processor 106, FIG. 1) to provide interconnection between electronic components such as sensor 201, display 205, alarm 120, C/F button 205 and battery 112. PCB 211 may further provide memory, e.g., memory 114.

System 200 may determine wine temperature according to operational logic shown and described with respect to FIGS. 8A-C. In one embodiment, system 200 automatically begins to monitor wine temperature once the system and attached wine bottle are removed from refrigeration.

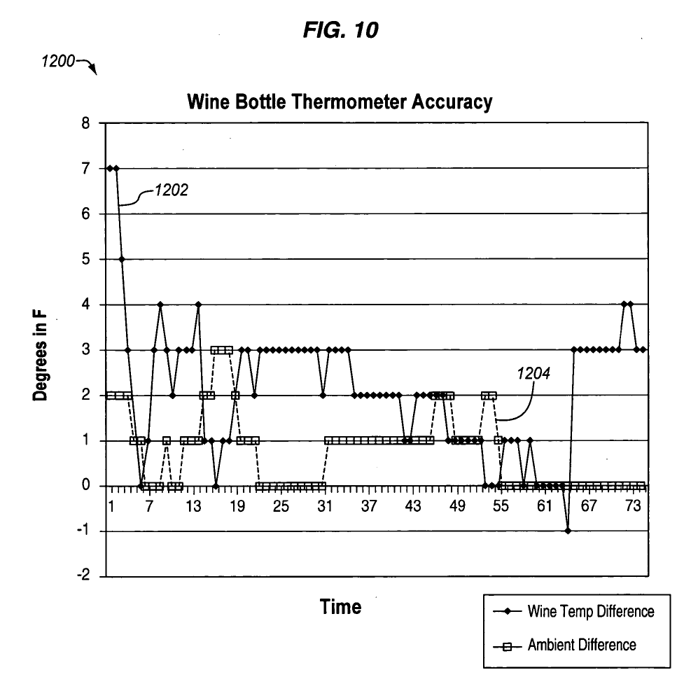

System 200 was tested to determine accuracy in measuring wine temperature, for example through algorithmic computations based upon bottle temperature and ambient temperature. Measurements of ambient temperature, bottle temperature and actual wine temperature and calculated wine temperature were recorded over a 93 minute time period. Differences between calculated and actual wine temperatures and ambient temperature and wine bottle temperature were calculated and the results plotted on graph 1200, FIG. 10. Over the 93 minute period, on average, system 200 calculated wine temperature within 2.14° F. of actual wine temperature, and measured ambient temperature within 0.78° F. of actual ambient temperature.

FIG. 2E shows a top view and FIGS. 2F-G show right- and left-side views, respectively, of one embodiment of a system 220 for measuring and monitoring wine temperature. As shown in FIG. 2E, display 108 may include an actual wine temperature reading 214 and a target wine temperature reading 215. C/F button 205 may be used to select or toggle between Celsius and Fahrenheit measurements of actual and target temperatures readings 214, 215. A user may also select a target wine temperature via an additional user interface, such as a Temp button 213. The selected target temperature may then be displayed as target temperature reading 215. Target wine temperature may be selected according to recommended temperatures for a particular type of wine, for example as listed in Table 2.

TABLE 2
Recommended Wine Drinking Temperatures by Varietal

| Temperature | | |
|---|---|---|
| ° F. | ° C. | Varietal |
| 68* | 20* | |
| 64 | 48 | Best Red Wines |
| 63 | 17 | Bordeaux |
| 61 | 17 | Chianti, Zinfandel, Red Burgundy |
| 59 | 15 | Cotes-du-Rhone |
| 57 | 14 | Best White Burgundy |
| 56 | 13 | Port Madeira, Ordinaires |
| 54 | 12 | Lighter red wines, e.g., Beaujolais |
| 52** | 11** | |
| 50 | 10 | Sherry |
| 48 | 9 | Roses, Fino Sherry |
| 46 | 8 | Most dry white wines, Lambrusco, Champagne |
| 43*** | 6*** | Most sweet white wines |
| 41 | 5 | Sparkling wines |

*Common Room Temperature
**IDEAL CELLAR TEMPERATURE
***Typical Domestic Refrigerator Temperature

Under certain conditions, a user may wish to modify recommended wine drinking temperatures. For example, when ambient temperature reading 207 falls below the recommended temperature for a wine, the user may wish to ignore the recommended temperature and instead set the target temperature a few degrees below ambient temperature reading 207. This may provide a wine drinker with an enhanced taste experience, as the wine may warm to ambient temperature, and vaporize slightly, while in a glass.

In one embodiment, a user may toggle between displaying ambient and wine temperature readings 207, 206, and actual and target temperature readings 214, 215, (described with respect to FIGS. 2H-I) on display 108. For example, a combination of button presses may allow a user to toggle between views on display 108. A user may therefore view ambient temperature reading 207, then toggle to view actual and target temperature readings 214, 215. The user may then set a target wine temperature based upon ambient temperature reading 207. In one embodiment, an alarm in communication with the processor (e.g., alarm 120 and processor 106, FIG. 1) and temperature sensor 201 visually and/or audibly notifies the user when the target wine temperature is reached.

Alternately, display 108 may serve as an alarm. An icon such as target wine temperature reading 215, or an additional symbol upon display 108, may flash when the target wine temperature is achieved. Display 108 may also warn the user of low battery status, for example, by flashing or steadily displaying a low battery icon 208.

FIG. 2H shows system 220 around a wine bottle 240. System 220 fits around the neck 241 of wine bottle 240, such that sensor 201 (not shown) contacts neck 241. As shown in FIG. 2I, system 220 has a height (hₛ), a length (lₛ) and a width (wₛ), and display 108 has a height (h_{d}) and a length (l_{d}). hₛ may be from about 60 to about 105 mm; lₛ may be from about 50 to about 60 mm; wₛ may be from about 15 to about 20 mm; lₛ may be from about 20 to about 30 mm, and h_{d} may be from about 11 to about 20 mm. In one embodiment, hₛ is 65 mm; lₛ is 55 mm; wₛ is 17 mm; l_{d} is 30 mm, and h_{d} is 10 mm.

FIGS. 2J-K depict front and back views, respectively, of one embodiment of a system for measuring and monitoring wine temperature. System 230 has a length (lₛ), a height (hₛ) and a width (wₛ). In one embodiment lₛ is about 54 mm, hₛ is about 101.2 mm and wₛ is about 26 mm. System 230 includes arm and body sections 101A, 101B; top 231; end 209; a bottom 232 and sides 233. Display 108 and C/F button 205 are positioned on end 209, along with a Mode button 219 and Wine Temp button 218. End 209 may be configured at a 90° angle relative to top, bottom and sides 231, 232, 233; however, in at least one embodiment, end 209 may be positioned at an obtuse angle with respect to top 231 and at an acute angle with respect to bottom 232, such that end 209 is slanted. Ambient temperature sensor 210 is disposed on a side 233; however, it is to be understood that these elements may be otherwise positioned, according to design requirements. For example, ambient temperature sensor 210 may be positioned upon top 231, bottom 232 or end 209.

Mode button 219 allows the user to select a mode of operation of system 230, such as a calibration mode, an intermittent or check mode and a constant mode. The calibration mode allows the user to calibrate temperature, for example adjusting ambient temperature reading 207 by pressing one or both of the C/F and Wine Temp buttons 205, 218. In one embodiment, pressing Wine Temp button 218 puts system 230 in calibration mode. Mode and C/F buttons 219, 205 may be pressed to adjust temperature up or down, respectively, by one degree per press. Wine Temp button 218 may also function to turn on display 108, which may switch to an energy-saving “sleep” mode after several minutes without user input.

Intermittent or check mode may allow for periodic monitoring and/or display of ambient and/or wine temperature, while constant mode provides for constant monitoring and display of wine and/or ambient temperature. In one embodiment, a user may select a mode by holding down the C/F and/or Wine Temp buttons 205, 218 and hitting Mode button 219 to toggle between, and select, the desired mode.

Bottom 232 of system 230 includes a battery compartment 212A, covered by battery cover 212. In one embodiment, battery cover 212 is a sliding cover. System 230 may be held together by one or more fasteners 221. In one embodiment, fasteners 221 are screws.

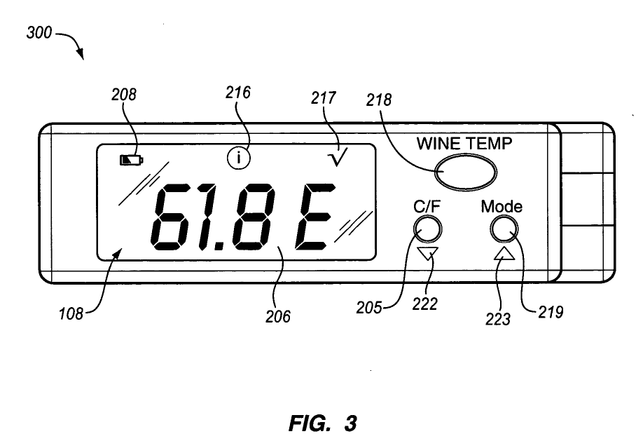

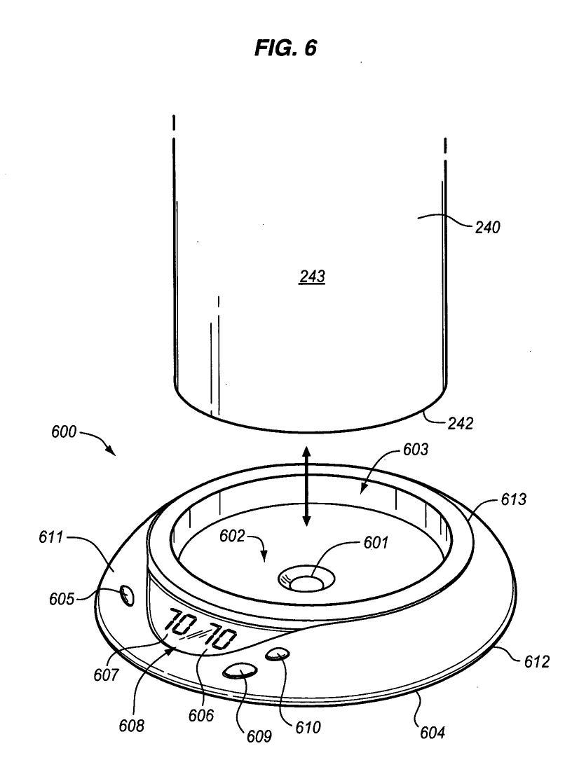

FIG. 3 shows a display panel 300, as may be utilized with any of previously described systems 100, 200, 220 and 230, and in particular with a coaster system 600, further described with respect to FIG. 6, below. In one embodiment, display panel 300 includes display 108 with Wine Temp button 218, Mode button 219 and C/F button 205. Pressing Wine Temp button 218 may “wake” display 108 from sleep mode so that the user may view a displayed temperature reading, such as wine temperature reading 206. In one embodiment, pressing Mode button 219 toggles between constant and intermittent or check modes, the latter indicated by check mode icon 217. A user wishing to conserve battery life (for example when low battery status is indicated by low battery icon 208) may select check mode via Mode button 219. In at least one embodiment, use of sleep and check modes may extend battery life beyond 360 hours.

In one embodiment, holding down Wine Temp button 218 puts the associated system, for example system 600, into calibration mode. Calibration mode may be indicated by calibration mode icon 216. The user may then press C/F button 205 to adjust the temperature up, as indicated by arrow marking 222, by one degree Celsius or Fahrenheit at a time. Temperature may be adjusted down by hitting Mode button 219, as indicated by arrow marking 223.

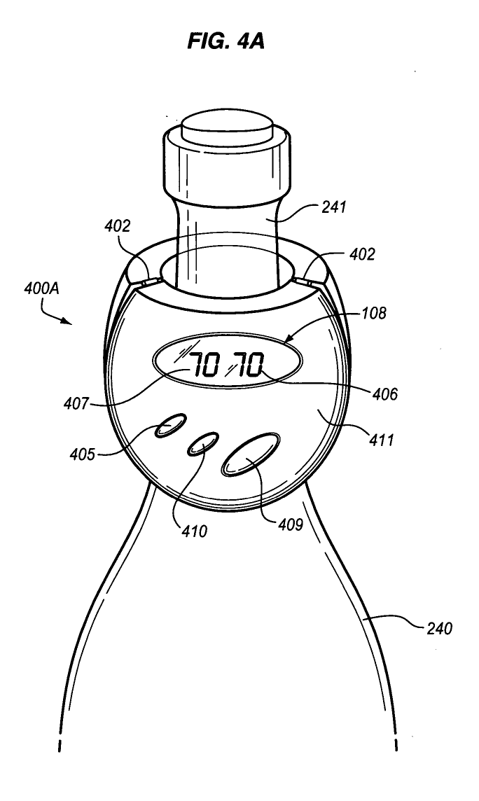

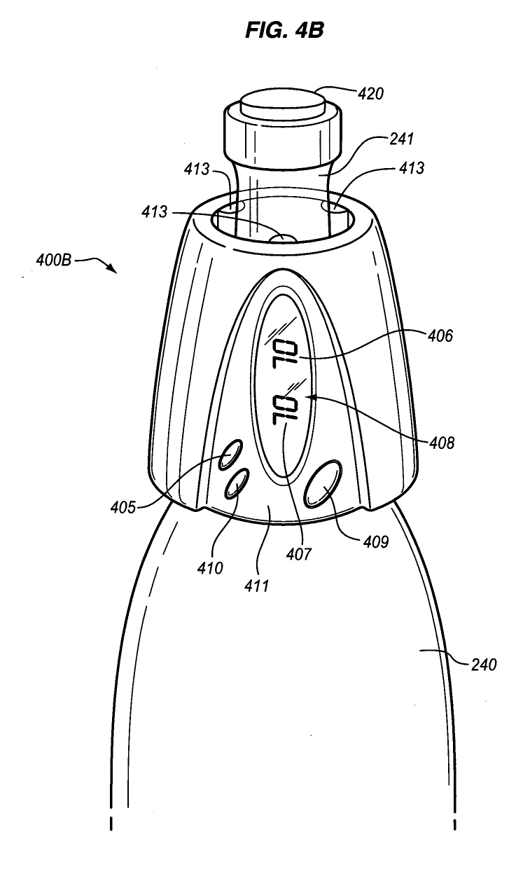

Although the embodiments described thus far include housings with arm and body sections, alternate configurations may be equally well utilized. For example, FIG. 4A shows a system for determining and monitoring wine temperature configured as a hinged clamp 400A, including hemispherical front and back sections 411, 412. Once placed over wine bottle 240, clamp 400A closes via hinges 402 to firmly grasp neck 241. This ensures good contact between neck 241 and a neck temperature sensor (not shown) disposed on an inner face of system 400A. When a user wishes to remove clamp 400A, it may be opened via hinges 402.

Display 108 and controls 405, 409 and 410 are positioned on hemispherical front section 411 to allow convenient user access. In one embodiment, horizontally-oriented display 108 shows temperature readings 406, 407, for example in response to user inputs communicated via controls 405, 409 and 410. Temperature readings 406, 407 may be represent ambient temperature, actual wine temperature or target wine temperature. Each of controls 405, 409 and 410 may be a C/F button, such as C/F button 205; a temperature button such as Temp button 213; a Mode button such as Mode button 219, or a Wine Temp button such as Wine Temp button 218. In at least one embodiment, controls 405, 409 and 410 are, respectively, a C/F button 405, a Wine Temp button 409 and a Mode button 410. A user may utilize various button presses to calibrate system 400A or set a desired temperature, for example as described previously with respect to FIG. 3.

FIG. 4B likewise shows one embodiment of an alternately-configured system for determining and monitoring wine temperature. Circumferential collar 400B slides over neck 241. Fingers 413 secure collar 400B to neck 241. In one embodiment, fingers 413 are made of a thermoplastic elastomer (TPE).

Collar 400B includes a display panel 411 with display 408, temperature readings 407 and 406 and controls 410, 409 and 405. In one embodiment, display 408 is a vertical LCD display; however, display 408 may be otherwise oriented.

Temperature readings 406 and 407 may represent ambient temperature, actual wine temperature or target wine temperature. Controls 405, 409 and 410 may serve as buttons described with respect to 4A, above.

The system for determining and monitoring wine temperature may also be configured as a cap 500 for fitting over a cork of wine bottle 240. Cap 500 includes a top face 511, with display 508 and control buttons 505, 509 and 510. Tapered, cylindrical body 502 connects to top face 511 and includes a bottle temperature sensor (not shown) on an inner surface, proximate the wine bottle neck, and one or more grips 503 on an outer surface, for facilitating placement and removal of cap 500 from bottle 240. In one embodiment, grips 503 are made from a TPE to provide a textured gripping surface. Top face 511 may be angled, or it may lie flat, i.e., parallel to the cork of bottle 240. In one embodiment, top face 511 is angled to facilitate viewing of display 508 and use of controls 505, 509 and 510 when bottle 240 is in an upright position, for example on a counter top.

Cap 500 may be sized large enough to fit a variety of wine bottle types. In one embodiment, one or more of controls 505, 509 and 510 may be utilized to select a wine bottle size, for example from the sizes listed in Table 3.

TABLE 3

| Common Name | | Volume of Wine |
|---|---|---|
| Split | 187 | mL |
| Half-bottle | 375 | mL, or |
| Bottle | 750 | mL |
| Magnum | 1.5 | L |
| Double Magnum/Jeroboam | 3 | L, |
| Rehoboam | 4.5 | L |
| Imperial or Methusalem | 6 | L |
| Salmanazer | 9 | L |
| Balthazar | 12 | L |
| Nebuchadnezzar | 16 | L |
| Sovereign | 50 | L |

Because differently sized wine bottles may have different bottle thicknesses, for example, a standard bottle having thinner glass than a Double Magnum, a processor (not shown) configured with cap 500 may require calibration up or down by several degrees, in order to account for different bottle thicknesses. In one embodiment, cap 500 automatically senses wine bottle size when placed over a wine bottle, and may self-calibrate according to the sensed size. In another embodiment, bottle size may be manually entered using one or more of controls 505, 509 and 510. In one embodiment, Cap 500 is a self-calibrating cap sized to fit commonly-purchased wine bottles, for example, Double Magnum or smaller wine bottles.

In at least one embodiment, cap 500 automatically determines and displays wine temperature when placed on a wine bottle. A user may press controls 505, 509 and 510 to calibrate cap 500, (for example according to bottle size or known ambient temperature) toggle between display units, toggle between display views or set a desired wine temperature. For example, control 505 may be a C/F button for selecting Celsius or Fahrenheit units for wine temperature and ambient readings 506, 507, or for adjusting temperature up when calibrating cap 500. Control 509 may be a Wine Temp button for initiating a calibration mode or for turning on display 508. Control 510 may be a Mode button, for toggling between constant and intermittent modes, for example, or for adjusting temperature down when calibrating cap 500. Controls 505, 509 and 510 may also be utilized in combination to toggle between display views, for example between a first view, wherein temperature reading 506 represents wine temperature and reading 507 represents ambient temperatures, to a second view, wherein readings 506 and 507 respectively represent actual and target wine temperatures.

Systems for determining and monitoring wine temperature need not necessarily fit around the neck or over the cork of a wine bottle, but may be configured to couple with the wine bottle at any position that ensures acceptable reading of wine temperature. For example, FIG. 6 shows one embodiment of a wine coaster 600 for measuring and monitoring wine temperature. Coaster 600 includes a coaster base 612 and a coaster top 613 with a central cavity 603 for accommodating the a wine bottle base 242 of a wine bottle 240. In one embodiment, cavity 603 is a circular cavity that is larger than the base 242 of a standard (750 mL) wine bottle, for example to accommodate champagne or larger-size bottles. In one embodiment, cavity 603 is sized to fit a particular wine bottle size, for example as selected from Table 3.

Cavity 603 includes a cavity base 602 and a sensor 601 disposed within inner base 602, for sensing temperature of wine bottle 240. In one embodiment, cavity base 602 is smooth, for easy cleaning. Sensor 601 may be a contact sensor, such as a thermocouple, or a non-contact sensor. In at least one embodiment, sensor 601 is an infrared (IR) sensor 601, and thus does not require direct contact with bottle base 242, but may be recessed in cavity base 602. IR sensor 601 directs an IR beam (not shown) to bottle 240. Reflected IR radiation bounces back from the bottle, and the wine within, and a processor, e.g., processor 106, averages the temperature within a beam of reflected IR radiation. IR sensor 601 is configured to sense temperature when pointed at an area of bottle 240 which contains wine. Coaster 600 may thus provide a particularly effective vehicle for infrared temperature measurement. Conveniently, coaster 600 provides for IR temperature measurement without opening bottle 240.

A variety of conventional techniques are known for calculating temperature on the basis of sensed IR spectra. In one aspect, this may be a blackbody technique. In another aspect, this may be done by multivariate regression analysis to relate temperature to the IR reflectance phenomenon, taking into consideration a standard range of values for bottle thickness, wine emissivity and the angle of the IR beam in relationship to the wine in the bottle. The ambient temperature may accordingly be tracked as a direct measurement on the basis of sensor signal input, as may be the temperature of the glass wine bottle. The temperature of wine within the bottle is affected by the rate of change in the ambient temperature and the heat conductive properties of the glass. In a non-static heat flux situation, the temperature of the wine in the glass bottle is not necessarily the same as the temperature of the glass, and may be appreciably different. In some embodiments, it is especially useful to perform a regression analysis that relates empirically observed temperature of wine within the bottle to these rate of change.

Minor calibration adjustments may be made by the processor, according to bottle type or size, to allow for accurate sensing despite differences in glass thickness among bottle sizes. In one embodiment, cavity base 602 is a pressure-sensitive base for sensing a wine bottle size. The processor may self-calibrate according to the bottle size sensed by cavity base 602. In one embodiment, cavity base 602 does not sense a wine bottle size, and wine bottle size is manually input, for example by pressing one or more of controls 605, 609 and 610. The processor may also calibrate according to factors such as the angle of IR reflection and wine emissivity.

Coaster 600 includes a display face 611, with display 608 showing temperature indicators 606, 607, and with controls 605, 508 and 610. Temperature indicators 606, 607 may indicate actual or target wine temperature, or ambient temperature. Controls 605, 609 and 610 may be, for example, C/F buttons, Wine Temp buttons, Mode buttons or other user interface buttons for programming or calibrating coaster 600. As described herein above with respect to FIGS. 3-4B, controls 605, 609 and 610 may be used, alone or in combination, to toggle between, select or set a temperature, display view or mode of coaster 600.

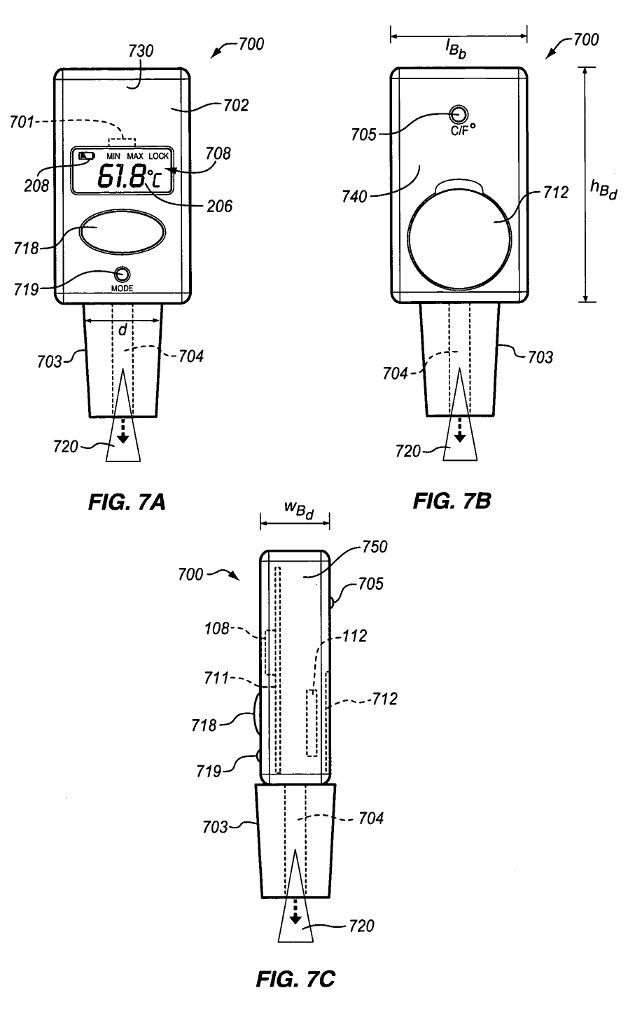

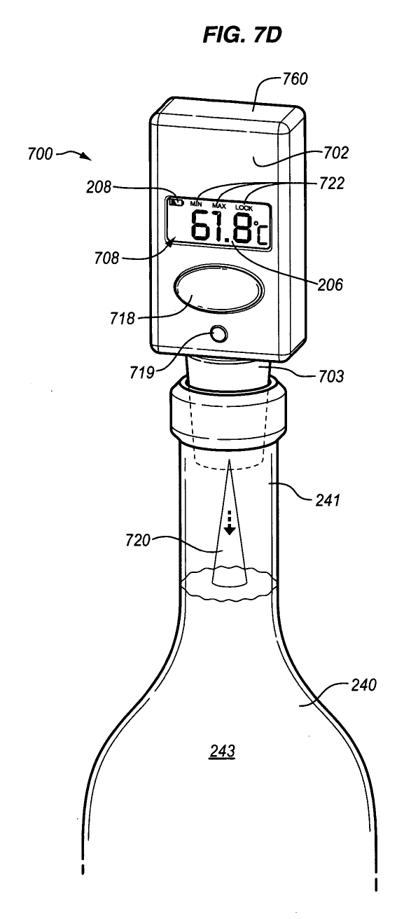

IR temperature sensing may also be employed in the embodiment of FIGS. 7A-D. FIG. 7A is a front view of a bottle stopper system 700 for determining and monitoring wine temperature. FIGS. 7B and 7C are back and side views of stopper system 700. Stopper system 700 includes a display body 702 and a stopper body 703. Display body 702 is shown having a rectangular shape; however, there is no requirement for this configuration. Display body 702 may take on a variety of shapes, as a matter of design preference. Display body 702 includes a front face 730, a rear face 740, one or more sides 750 (for example, the display body may include one continuous side 750 when the display body is circular or ovate) and a top face 760. When the display body is circular or ovate, top face 760 may be continuous with side 750.

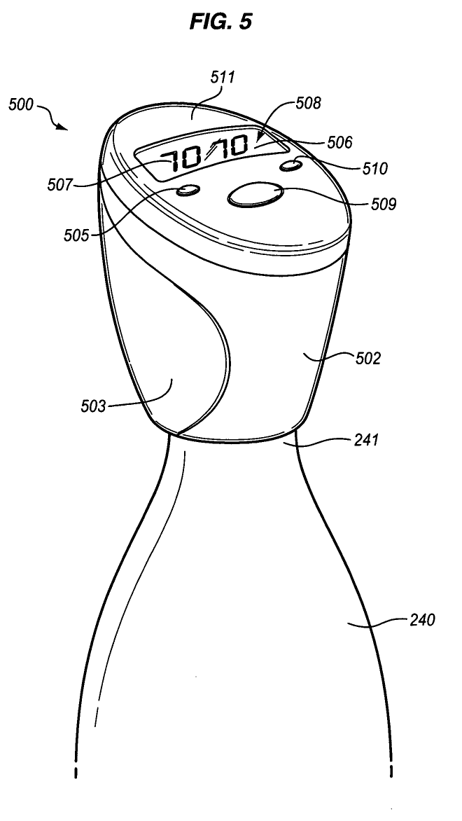

Front face 702 includes a Wine Temp button 718 and a Mode button 719. Wine Temp and Mode buttons 718, 719 may be pressed to achieve the modes and functions previously described herein, for example, with respect to FIGS. 3-5. A display 708 displays at least one temperature reading 206. Depending upon commands received via Wine Temp and Mode buttons 718, 719, temperature reading 206 may convey actual wine temperature, target wine temperature or ambient wine temperature. Display 708 is depicted as a horizontal, rectangular display; however, display 708 may equally be rounded, ovate or otherwise shaped, and need not be oriented horizontally.

Stopper system 700 may replace a wine bottle cork. For example, stopper body 703 may be shaped as a tapered cylinder, in order to ensure a tight fit in the neck of a wine bottle. A user may apply a downward force or a downward, twisting force to display body 702, in order to tightly fit stopper body 703 in the neck of the wine bottle.

In at least one embodiment, stopper system 700 includes a vertically mounted, internal electromagnetic sensor 701, depicted by a dotted box in FIG. 7A. Once stopper system 700 is secured within the wine bottle neck, a user may activate wine temperature sensing, for example by pressing Wine Temp button 718. Sensor 701 directs IR radiation 720 at wine within the bottle, through an IR chamber 704 extending through stopper body 703. IR radiation 720 may be emitted as a beam or cone. Overall wine temperature may be determined as an average of temperature measurements of wine within the beam or cone, and displayed on display 708.

A user may select Celsius or Fahrenheit units of temperature measurement, by pressing C/F button 705, disposed in one embodiment on the back face 740 of stopper system 700. A processor may utilize an algorithm to convert between Celsius and Fahrenheit temperature measurements, for example as described with respect to FIG. 1. Rear face 740 may further include a battery cover 712 covering a battery compartment, e.g., battery compartment 212A, and battery 112. As shown in side view FIG. 7C, stopper system 700 may include a printed circuit board 711, for providing connections between components and/or for providing memory, e.g., memory 114.

Display body 702 may have a length (l_{Bd}) of about 25-35 mm, a height (h_{Bd}) of about 70-90 mm and a width (w_{Bd}) of about 10-20 mm. Stopper body 703 may have a range of diameter (d) consistent with a variety of cork sizes. In one embodiment, l_{Bd} is approximately 31 mm, h_{Bd} is about 79.5 mm and w_{Bd} is about 16 mm.

FIG. 7D shows stopper system 700 in a wine bottle 240. Stopper body 703 fits securely into bottle neck 241. Stopper system 700 may be set in constant readout mode, such that sensor 701 constantly monitors wine temperature, or stopper system 700 may be set in check mode, such that sensor 701 measures wine temperature when Wine Temp button 718 is pressed. As described with respect to FIG. 1, stopper system 700 may include an audio or visual alarm (not shown) to inform a user when a target wine temperature is achieved. Display 708 further includes icons 722, for relating operational or mode status. For example, an icon 722 may indicate a minimum or maximum temperature, a mode, and/or whether system 700 is locked in a particular mode or display view.

FIG. 8A is a flowchart illustrating one exemplary process 800 for determining wine temperature, for example as utilized by system 200. Process 800 is, for example, implemented within algorithm 116, FIG. 1. Process 800 shows a control logic loop that continually monitors ambient temperature and wine bottle neck temperature, for example using sensors 210, 201.

Process 800 begins with decision 801. If the ambient temperature is less than 32° F., an LCD flashes, for example to notify a user of extremely cool conditions, in step 802. The LCD may, for example, be a visual alarm 120 (FIG. 1), or a flashing display 108. Alternately, an LED or audio indicator may be utilized in place of, or in addition to, the LED.

If the ambient temperature is greater than 32° F., the system, e.g., system 200, initiates constant display mode, in step 803. System 200 may, for example constantly display both ambient and wine temperature on display 108. If the user prefers the Celsius scale for monitoring temperature, he or she may press the C/F button (e.g., C/F button 205). Step 804 is thus a decision. If the C/F button is pressed, the display toggles between Celsius and Fahrenheit temperature measurements, in step 805. If the C/F button is not pressed, the thermometer continues in constant display mode, step 803.

It is to be understood that the system continually measures ambient and wine temperature while in constant display mode. Step 806 is a decision. If the rate of ambient temperature change exceeds 10° F. in one minute, measured ambient temperature is subtracted from a base temperature of 70° F. to achieve an ambient temperature difference, and a timer (e.g., timer 118) is started, in step 808. Step 809 is another decision. If the ambient temperature difference is less than zero (i.e., the ambient temperature is greater than the base temperature of 70° F.), an error is noted, in step 810. If, on the other hand, the ambient temperature difference is greater than or equal to zero (i.e., ambient temperature is less than or equal to 70° F.) process 800 next initiates a sensor lag adjustment routine, further described herein below with respect to FIG. 8B.

FIG. 8B depicts sensor lag adjustment process 900. Process 900 commences with decision 901. If the elapsed time (for example as commenced in step 808) is less than or equal to one hour, a further decision 902 determines whether the elapsed time is less than or equal to twenty minute. If twenty minutes or less have elapsed, the elapsed time is multiplied by 2, in step 903A. 20F is subtracted from the ambient factor, in step 904A. The resulting ambient factor is added to the ambient temperature in step 905A. Returning to decision 902, if the elapsed time is greater than 20 minutes, the elapsed time is multiplied by 0.2, in step 903B. The result of either step 903B (elapsed time×0.2) or step 905A (ambient temperature+ambient factor) is added to the bottle neck temperature, at step 906, sensor lag adjustment process 900 completes, and process 800 continues at step 811, further described herein below.

Returning to decision 901, if the elapsed time is greater than one hour (60 minutes), a further decision 907 determines whether the elapsed time is greater than or equal to one and one-half hour (90 minutes). If 90 minutes or more have elapsed, step 911 adds 0° F. to the ambient factor (i.e., ambient factor is unchanged), and the ambient temperature and ambient factor are summed, in step 912. Sensor lag adjustment process 900 completes, and process 800 resumes in step 811.

If, on the other hand, it is determined that less than 90 minutes have elapsed, in decision 907, wine temperature is compared with ambient temperature, in decision 908. If wine temperature is equal to ambient temperature, the clock icon shuts off, process 900 completes, and monitoring mode resumes, step 909B, for example, resuming at step 803 of process 800. If, however, the wine temperature and ambient temperature are not equal, 1° F. is added to the ambient factor in step 909A. The resultant ambient factor is then added to the ambient temperature, in step 910A, process 900 completes, and process 800 resumes at step 811.

In step 811, bottle neck temperature is subtracted from ambient temperature to achieve an ambient-neck temperature difference. The ambient-neck temperature difference is multiplied by 0.2, in step 812. Step 813 is a decision. If elapsed time is greater than five minutes, decision 815 determines whether elapsed time is greater than 10 minutes. If so, a further decision 816A determines whether the ambient temperature is greater than 80° F. If so, 15° F. is added to the result ambient temperature difference (e.g., as calculated in step 812), in step 817A and wine temperature is displayed in step 818. If decision 816A determines that the ambient temp is cooler than 80° F., 5° F. is added to the result ambient temperature difference (e.g., of step 812), in step 820 and wine temperature is displayed in step 821. Step 822 is a decision. If the ambient temperature and wine temperature are equal, process 800 continues monitoring the rate of change every 30 seconds, step 807, determining whether the ambient temperature is less than 32° F., step 801 and continuing through the appropriate of steps 802-824 based upon the measured ambient temperature.

Returning to step 815, if the elapsed time is less than or equal to ten minutes, decision 816B determines whether the ambient temperature is greater than 80° F. If so, 110° F. is added to the result ambient temperature difference, in step 817B, and wine temperature is displayed at step 818.

If the ambient temperature is cooler than 80° F. (Decision 816B), initial wine temperature adjustment commences, as outlined in process 800, FIG. 6C. Likewise, if the elapsed time is determined to be less than five minutes in decision 813, initial wine temperature adjustment commences after 5° F. is added to the result ambient temperature, in step 814.

8C depicts an initial wine temperature adjustment process 1000. Process 1000 commences with decision 1001. If the elapsed time is less than or equal to one minute, 8° F. is added to the wine temperature, in step 1002. If more than one minute has passed, decision 1003 determines whether two minutes or less have passed, in which case 7° F. is added to the wine temperature, in step 1004. If more than two minutes have passed, a determination is made as to whether more than three minutes have passed. If the elapsed time is less than three minutes, 6° F. is added to the wine temperature, in step 1006. If more than three minutes have passed, decision 1007 determines whether the elapsed time is less than or equal to four minutes. If so, 5° F. is added to the wine temperature in step 1008. If more than four minutes have passed, decision 1009 determines whether more than five minutes have passed. If the elapsed time is less than or equal to five minutes, 4° F. is added to the wine temperature. If the elapsed time exceeds five minutes, a determination is made as to whether more than six minutes have passed, decision 811. If the elapsed time is less than or equal to six minutes, 3° F. is added to the wine temperature. If the elapsed time exceeds six minutes, the wine temperature is unchanged (0F added, step 1013), and the initial wine temperature adjustment process 1000 ends. Process 1000 likewise ends after the appropriate number of degrees Fahrenheit added in steps 1004, 1006, 1008, 1010 or 1002.

Following initial wine temperature adjustment, process 800 resumes and decision 824 determines whether the elapsed time is greater than 15 minutes and whether the wine temperature is less than 70° F. If so, the calculated wine temperature is reduced by 4° F., in step 826. Steps 824, 826 continue until the elapsed time exceeds 15 minutes and the wine temperature is less than 70° F. Wine temperature is then displayed, in step 818.

In this context, it will be appreciated that various temperature measurements are taken sequentially at intervals of time. Finite difference techniques may be employed to calculate other parameters that may be displayed as an alternative or in addition to the display parameters that have been discussed above. For example, a first forward difference technique may be used to smooth historical data that may be solved as a first order least square regression relating temperature to time and, consequently, the regression may be solved to calculate a remaining time that is required to attain the target temperature. In this embodiment, the remaining time may be displayed. It will be understood that any suitable regression technique may be employed to relate time to temperature, and that this is only an approximation.

FIG. 9 is a graph 1100 illustrating relationships between wine bottle neck temperature and wine temperature at ambient temperatures of 70° F. and 87° F. over a period of time as observed during experimentation. Lines 1101, 1102 represent changes in neck temperature and wine temperature, respectively, over approximately 45 minutes at an ambient temperature of 87° F. Line 1105 illustrates the difference between neck and wine temperatures at the same ambient temperature (87° F.), over the same time period. Lines 1103, 1104 represent changes in neck and wine temperatures, and line 1106 represents the difference therebetween, at an ambient temperature of 70° F. over approximately 45 minutes. Line 1107 is a calculation result that has been produced as a projected value according to the finite difference techniques described above, and which shows good conformity with empirical results.

FIG. 10 is a graph 1200 showing experimental results obtained in testing a system for determining and monitoring wine temperature. Line 1202 shows difference between calculated and actual wine temperature over an 85 minute time period (as noted above, testing lasted for 93 minutes, however, measurements taken between 85 and 93 minutes did not significantly impact results and are not depicted in graph 1200). Line 1204 shows differences between ambient temperature measured by system 200 and actual ambient temperature, as measured by an independent thermometer. Again, ambient temperature difference is shown over a period of 85 minutes.

Changes may be made in the above methods and systems without departing from the scope hereof. For example, display 108 may be used to display other temperatures or parameters of wine temperature. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A system for determining and monitoring wine temperature, comprising:
a housing;
a first temperature sensor supported by the housing and configured to produce first signals representative of an ambient temperature;
a second temperature sensor supported by the housing and configured to produce second signals representative of a wine bottle temperature; and
a processor supported by the housing and operably configured to act upon the first and second signals to determine a wine temperature of wine within a wine bottle.

2. The system of claim 1, further comprising a user interface configured with the housing for selecting a temperature scale.

3. The system of claim 2, the temperature scale comprising the Celsius or the Fahrenheit scale; the processor configured for converting between a Fahrenheit temperature and a Celsius temperature.

4. The system of claim 1, further comprising a display in communication with the first and second temperature sensors and the processor, operable for displaying one or more of the ambient temperature, a determined wine temperature and a target wine temperature.

5. The system of claim 4, further comprising a user interface configured with the housing for selecting one or more of the target wine temperature and an operational mode.

6. The system of claim 5, the operational mode comprising one of a constant mode for continually monitoring one or both of wine bottle temperature and ambient temperature; an intermittent mode for periodically monitoring one or both of wine bottle temperature and ambient temperature, and a calibration mode for calibrating the system.

7. The system of claim 1, the processor having an algorithm for calculating the wine temperature based upon the ambient temperature, the wine bottle temperature and one or more of the rate of change of ambient temperature, the rate of change of wine bottle temperature and the size of the wine bottle.

8. The system of claim 1, further comprising an alarm in communication with the second temperature sensor, for signaling when the wine temperature reaches a selected target temperature.

9. The system of claim 8, the alarm comprising a visual or audible alarm.

10. The system of claim 1, the housing comprising an elliptical opening for accommodating the neck of the wine bottle.

11. The system of claim 10, further comprising a spring configured with the second temperature sensor, the temperature sensor disposed at the opening, the spring configured for ensuring contact between the second temperature sensor and the neck.

12. The system of claim 11, further comprising an arm section defining a first half of the elliptical opening and a body section attached to the arm section defining the second half of the elliptical opening.

13. The system of claim 12, further comprising a hinge attaching the arm and body sections at a first side of the housing, the housing configured to open at a second side when the arm and body sections pivot at the hinge.

14. The system of claim 1, the housing comprising a collar configured for fitting a wine bottle neck.

15. The system of claim 1, the housing comprising a clamp configured for clamping a wine bottle neck.

16. The system of claim 1, the housing comprising a coaster with a cavity for accommodating a base of the wine bottle, the second sensor disposed within the cavity.

17. The system of claim 16, the sensor comprising an infrared sensor.

18. The system of claim 1, the housing comprising a cylindrical cap configured to fit over a top of the wine bottle.

19. The system of claim 18, the cylindrical cap configured to fit over a cork of the wine bottle.

20. The system of claim 1, the housing comprising a stopper configured to cork the wine bottle, the second temperature sensor comprising an infrared temperature sensor operable for directing infrared radiation at wine in the wine bottle.

21. The system of claim 20, the infrared temperature sensor configured for detecting a wavelength of light emitting from wine in the wine bottle, the processor configured for processing the wavelength to determine a temperature of the wine.

22. The system of claim 1, wherein the processor is configured with program instructions relating a rate of temperature change in the ambient environment and a rate of temperature change in the glass bottle to the temperature of wine within the bottle.

23. A coaster for determining and monitoring beverage temperature, comprising:
a base;
a top having a cavity for accepting a beverage container;
a temperature sensor disposed within the cavity and configured to produce signals representative of a temperature of a beverage within the beverage container.

24. The coaster of claim 23, wherein the temperature sensor is an infrared sensor.

25. The coaster of claim 23, wherein the beverage is wine and the beverage container is a wine bottle.

26. A method of determining wine temperature, comprising:
sensing a first temperature of a wine bottle;
sensing a first ambient temperature; and
processing the first ambient temperature with the first wine bottle temperature to determine a temperature of wine within the wine bottle.

27. The method of claim 26, wherein one or more of sensing a temperature of a wine bottle and sensing an ambient temperature comprise infrared sensing.

28. The method of claim 26, further comprising displaying one or more of the wine bottle temperature, the ambient temperature and the wine temperature.

29. The method of claim 26, further comprising accepting one or more user inputs.

30. The method of claim 29, the user input comprising a target wine temperature.

31. The method of claim 30, the processor configured to compare the wine temperature with the target wine temperature.

32. The method of claim 31, further comprising notifying a user when the wine temperature and the target temperature are equal.

33. The method of claim 31, further comprising notifying a user when the wine temperature exceeds or falls below the target temperature.

34. The method of claim 29, the user input comprising a request to display a measured temperature in degrees Celsius or degrees Fahrenheit.

35. The method of claim 34, further comprising converting the measured temperature between Celsius and Fahrenheit units.

36. The method of claim 26, further comprising:
sensing a second wine bottle temperature;
processing the second wine bottle temperature with the first wine bottle temperature to determine a rate of wine bottle temperature change;
sensing a second ambient temperature;
processing the second ambient temperature with the first ambient temperature to determine a rate of ambient temperature change; and
processing the rate of wine bottle temperature change with rate of ambient temperature change to determine the wine temperature.

37. The method of claim 36, further comprising:
accepting a wine bottle size;
processing the wine bottle size with the rate of wine bottle temperature change and the rate of ambient temperature change to determine the wine temperature.
